(19) United States
(12) Patent Application Publication
(10) Pub. No.: US 2017/0360224 A1
(43) Pub. Date: Dec. 21, 2017

(54) THERMOPLASTIC POLYMER IMAGE DISPLAY DEVICE

(71) Applicant: Kelvin Shane Mitchell, Airdrie (CA)

(72) Inventor: Kelvin Shane Mitchell, Airdrie (CA)

(21) Appl. No.: 15/183,743

(22) Filed: Jun. 15, 2016

(51) Int. Cl. A47G 1/06; B32B 27/06

(52) U.S. Cl. CPC A47G 1/06; B32B 27/06; A47G 1/065; A47G 2001/0677; B32B 2307/412; B32B 2457/20

(57) ABSTRACT

An image display device for displaying wall art, comprising: a transparent top layer comprising a thermoplastic polymer, wherein the transparent top layer comprises a first side and a second side, and wherein the top layer overlays a viewing side of at least one image.

### FIELD OF THE INVENTION

The present disclosure is in the field of image display devices and process of preparation thereof.

### BACKGROUND OF THE DISCLOSURE

Current providers of graphic art media are provided to meet a range of customers needs. Commercially produced graphic art media to be wall hung is generally susceptible to damage from smearing, liquids, scratches and may be damage by merely touching the surface of the graphic art. In another aspect, the post-laminating techniques subsequent to the formation of the subject printed material are time consuming and not economical. Additional problems with the post-lamination process may include wrinkles, curling, delamination, bubbles and other defects.

Therefore, there is need for a convenient and economical thermoplastic polymer derived image display device and method of production for the same that overcomes the issues associated with other techniques.

### SUMMARY OF THE INVENTION

Disclosed herein is an image display device for displaying wall art, comprising: a transparent top layer comprising a thermoplastic polymer, wherein the transparent top layer comprises a first side and a second side, and wherein the top layer overlays a viewing side of at least one image.

In another aspect, disclosed herein is a method for producing an image display device for displaying wall art, comprising providing a transparent top layer capable of being printed upon with a printing device, wherein the top layer comprises a first side and a second side, and wherein the transparent top layer overlays a viewing side of at least one image.

### BRIEF DESCRIPTION OF THE DRAWINGS

FIG. 1 is an exploded illustration of an image display device 100 comprising at least one image 214 with a viewable side 106 as disclosed herein.

FIG. 2 is an illustration of an image display device 200 comprising a transparent top layer with a plurality of square and/or rectangular portions 202, 204, 206, 208, 210 and 212 capable of being folded and affixed in a cube shape comprising at least one image 214 viewable from one or more sides.

FIG. 3 is an illustration of an image display device 300 comprising a cube shape with at least one image 214 with a viewable side 106 as disclosed herein.

FIG. 4A is an illustration of an image display device 400 comprising a cone shape with at least one image 214 with a viewable side 106 as disclosed herein.

FIG. 4B is an illustration of an image display device 500 comprising a pyramid shape with at least one image 214 with a viewable side 106 as disclosed herein.

FIG. 4C is an illustration of an image display device 600 comprising a sphere shape with at least one image 214 with a viewable side 106 as disclosed herein.

FIG. 4D is an illustration of an image display device 700 comprising a cylinder shape with at least one image 214 with a viewable side 106 as disclosed herein.

FIG. 5A is an illustration of a ridge shaped texture 800 of an image display device 100 disclosed herein.

FIG. 5B is an illustration of a wave shaped texture 900 of an image display device 100 disclosed herein.

FIG. 5C is an illustration of a arc shaped texture 1000 of an image display device 100 disclosed herein.

FIG. 5D is an illustration of a saw tooth shaped texture 1100 of an image display device 100 disclosed herein.

### DETAILED DESCRIPTION OF THE EMBODIMENTS

The following is a detailed description of certain specific embodiments of the image display devices and methods disclosed herein.

In one aspect, disclosed herein is an image display device for displaying wall art, comprising: a transparent top layer comprising a polymer selected from the group consisting of a propylene-ethylene copolymer, a high density polyethylene polymer and a low density polyethylene polymer and polypropylene, wherein the transparent top layer comprises a first side and a second side, and wherein the top layer overlays a viewing side of at least one image, wherein the transparent top layer comprises an image enhancing coating. In some embodiments, the top layer is polypropylene.

The thermoplastic polymer derived layers of the disclosure are useful for printing images. The images may be applied from an ink jet printing method or a thermal transfer process. The thermoplastic polymer derived layers may be printed upon employing a printing press with a master printing plate or printed via an intermediate substrate. Moreover, images may be printed onto a polymer derived layer employing Retro-gravure printing processes and with a template. In some embodiments, Retro-gravure printing process employs a metal cylinder template. Another method of printing images onto the thermoplastic polymer derived layer is flexographic printing. In some embodiments, the flexographic printing is performed using a Flexopress™.

With the red and blue tints and/or an optical brightener added into the film, the printed image on the surface shows an intensified clarity and brightness. In addition, the image resolution is greatly improved. These films are suitable for packaging and label applications where high image quality is desired.

The thermoplastic polymer layer of the present disclosure may be of any thickness. In some embodiments, the thermoplastic polymer layer has a total gauge thickness between about 0.3 mil and 5 mil. Polypropylene is because of its excellent physical properties and suitability for thin film manufacturing. The layer thickness ranges disclosed herein are per sheet and the total thickness may increase depending on the number of layers.

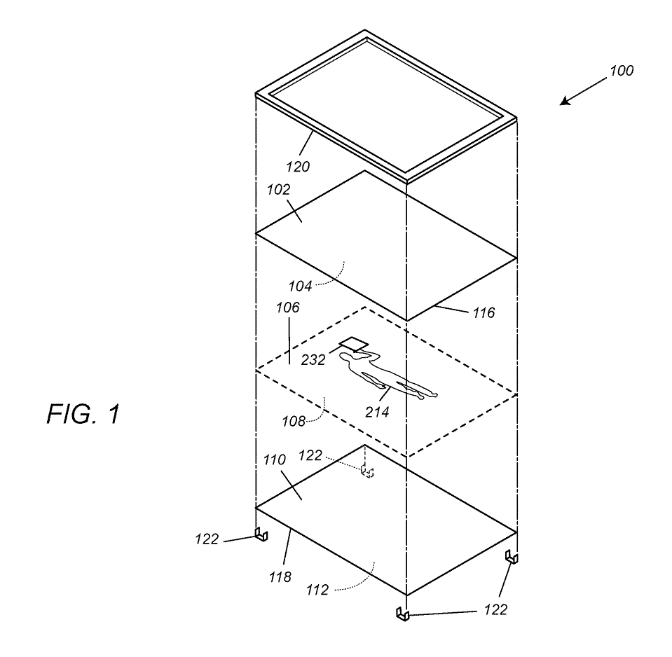

Turning to the drawings, FIG. 1 depicts an exploded view of an image display device 100 as disclosed herein. The image display device 100 comprises at least one image 214 with a viewable side 106 and an opposite side 108. In some embodiments, the image is printed on the second side of the transparent top layer 116. In this aspect, the image may be printed on a second side 104 of the transparent top layer 116 with the viewable side 106 of the image 214 with the object 232 observable on the right via a view from the first side 102 of the transparent top layer 116. Therefore, the image may be printed on the second side 104 of the transparent top layer 116, whereby the opposite side 108 of the image 214 is observed from the second side 104 of the transparent top layer 116 and the viewable side 106 of the image 214 with the object 232 observable on the right side. The image display device 100 may comprise a mount affixed to the wall frame 120. In some embodiments, the image display device 100 is affixed to a wall frame 120 via fasteners 122. In some embodiments, the image display device 100 is fastened to the backside of the frame 120 and the frame is a finished wood, metal and/or plastic frame. Alternatively, the image display device 100 may be stretched over the top face of the frame 120 the edges of the image display device 100 fastened to the back of the frame 120 via fasteners 122. In this manner, the image 214 is protected from damage due because the image has been printed with the viewable side 106 of the image 214 overlaid with the transparent top layer 116. During the printing process the opposite side 108 of the image 214 as it is being printed on the second side 104 of the transparent top layer 116.

As depicted with the exploded view of FIG. 1, the image display device 100 may comprise a bottom layer 118. The first side 110 of the bottom layer 118 may be laminated to the second side 104 of the transparent top layer 116 following the printing of the image 214. In some applications, the at least one image 214 is printed on the first side 110 of the bottom layer 118, whereby the viewable side 106 of the image 214 viewed from the first side 110 of the bottom layer 118 with the object 232 observable on the right side. In some embodiments, the bottom layer 118 and the transparent top layer 116 are subjected to a laminating process. In some embodiments, the bottom layer 118 and the transparent top layer 116 are subjected to a laminating process with a non solvent adhesive. In some embodiments, the image display device further comprises a bottom layer, wherein a first side of the bottom layer is affixed to the second side of the top layer. In some embodiments, the image display device further comprises a bottom layer, wherein the bottom layer is affixed to the second side of the top layer, and wherein the at least one image is printed on a first side of the bottom layer. In some embodiments, the image display device further comprises a bottom layer, wherein the bottom layer is affixed to the second side of the top layer, and wherein the bottom layer is metalized. In some embodiments, the image display device further comprises a bottom layer, wherein the bottom layer is affixed to the second side of the top layer, wherein the bottom layer is metalized, and wherein a metal used for the metalized bottom layer is aluminum. In some embodiments, the image display device further comprises a bottom layer, wherein the bottom layer is affixed to the second side of the transparent top layer, wherein the bottom layer is metalized, wherein a metal used for the metalized bottom layer is aluminum, and wherein the image is printed on a first side of the metalized bottom layer.

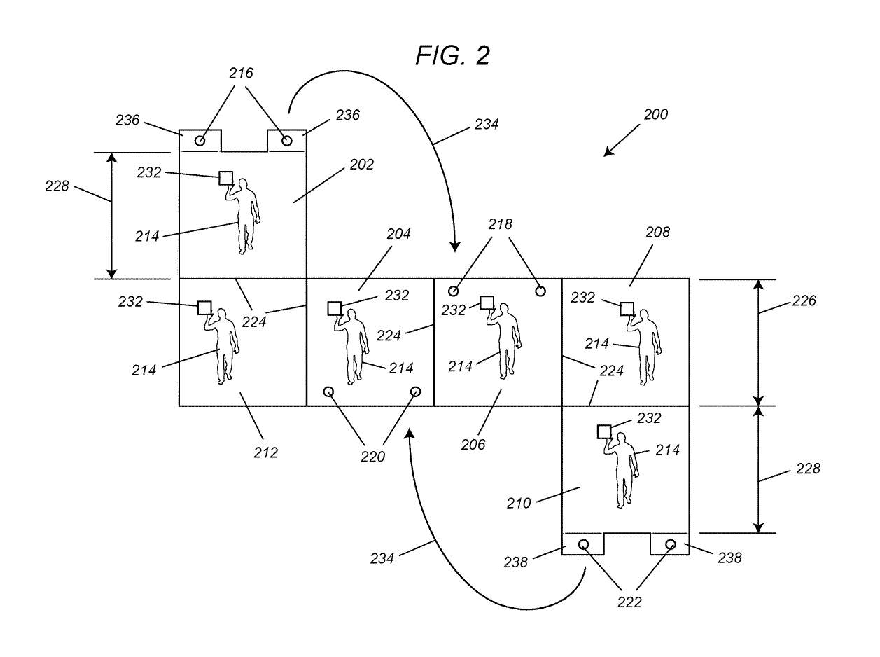

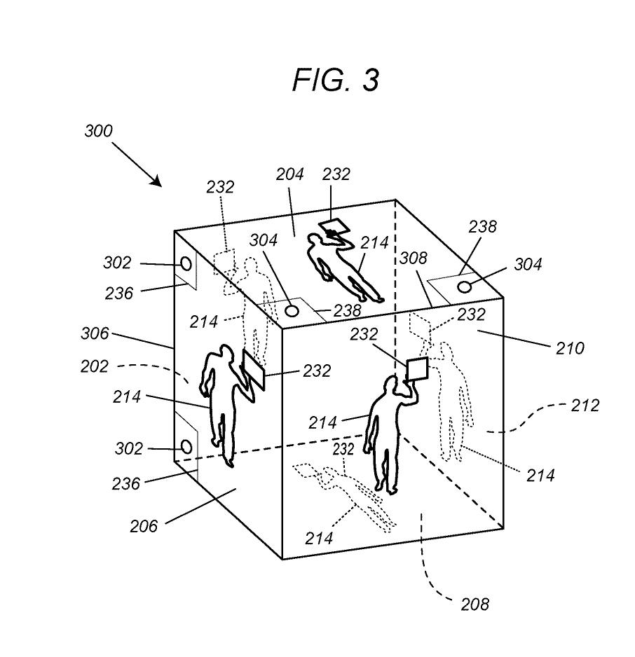

Turning to FIGS. 2 and 3, the image display device 200 of FIG. 2 comprises a plurality of square and/or rectangular portions 202, 204, 206, 208, 210 and 212 are capable of being folded and affixed in a cube shape comprising at least one image 214 viewable from one or more sides. As depicted with folding arrow directions 234, 230 and 232, the image display device 200 is folded into an image display device 300 comprising a cube shape with at least one image 214 with a viewable side 106. The image display device 200 comprises attachment positions 216 and 222 for affixing the square and/or rectangular portions 202 and 210 to attachment positions 218 and 220 of the square and/or rectangular portions 206 and 204, respectively via one or more fasteners 302 and 304. The square and/or rectangular portions 202, 204, 206, 208, 210 and 212 may be folded along segments 224, which may comprise thinner regions of the bottom layer 118 and/or the transparent top layer 116. Alternatively, the folding along segments 224 is accomplished following a heating step of the thermoplastic layer(s) to allow for formation of a cube and a subsequent cooling stage thereby forming a rigid cube of an image display device 300 as disclosed herein. In some embodiments, the length 228 may be about 5% to 20% longer than length 226, which allows for attachment positions 216 and 222 to be folded over to be aligned with attachment positions 218 and 220. In some embodiments one or more of the attachment positions 216 and 222 comprise one or more tabs 236 and 238 to be folded over to be aligned with attachment positions 218 and 220. In some embodiments, the fasteners 302 and 304 comprise rivets and/or screws. In some embodiments the square and/or rectangular portions 202 and 210 are affixed to square and/or rectangular portions 206 and 204 with adhesive along seams 306 and 308. In some embodiments the square and/or rectangular portions 202 and 210 are affixed to square and/or rectangular portions 206 and 204 with adhesive and the tabs 236 and 238.

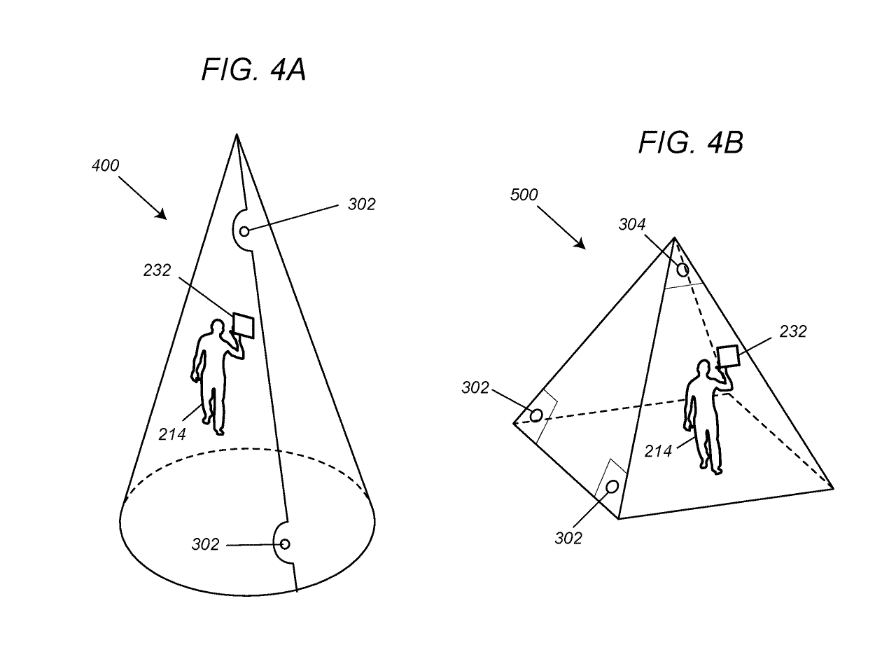

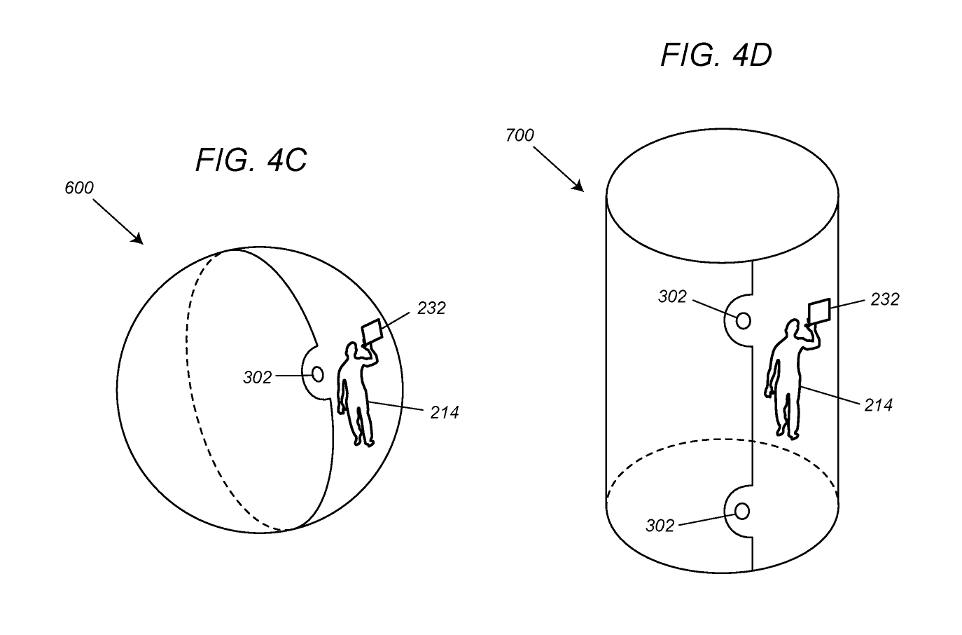

Turning to FIGS. 4A, 4B, 4C and 4D, and in similar fashion the image display device 200 of FIG. 2 and the formation of the image display device 300 comprising a cube shape, the image display device 100 may be printed on a appropriately shaped bottom layer 118 and/or the transparent top layer 116 and folded and affixed into a cone shaped image display device 400 comprising at least one image 214 with a viewable side 106. In this manner, FIG. 4B is an illustration of an image display device 300 comprising a pyramid shape with at least one image 214 with a viewable side 106 as disclosed herein. FIG. 4C is an illustration of an image display device 300 comprising a sphere shape with at least one image 214 with a viewable side 106 as disclosed herein. FIG. 4D is an illustration of an image display device 300 comprising a cylinder shape with at least one image 214 with a viewable side 106 as disclosed herein.

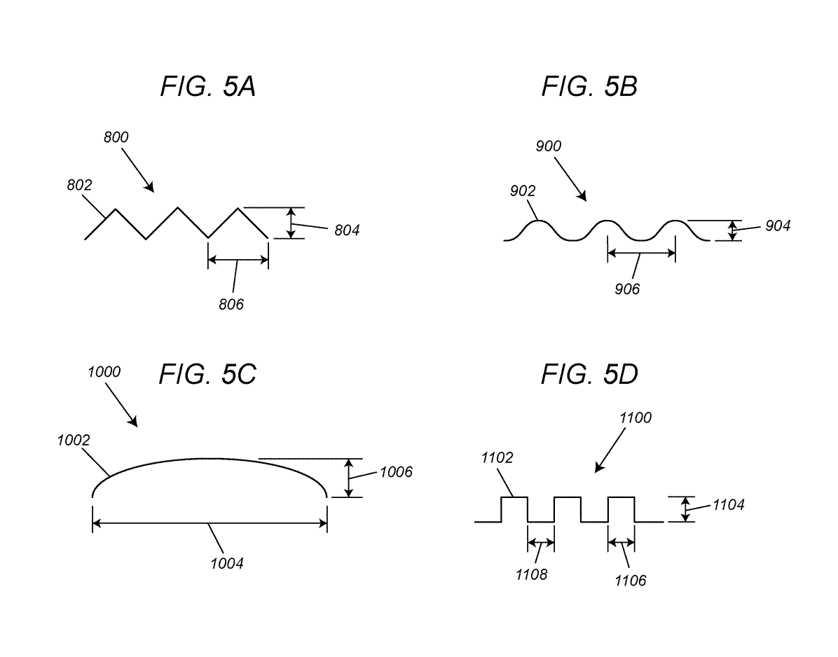

Turning to FIGS. 5A, 5B, 5C and 5D, the image display device as disclosed herein may be treating with heat in the presence of a mold comprised of the shapes 802, 902, 1002 and/or 1102 as depicted with FIGS. 5A, 5B, 5C and 5D, respectively. For example, the mold may comprise two opposed rigid wave surfaces 802 which may be used under heat to mold the image display device 100 affording a 3-demensional effect to the image with the contorted bottom layer 118 and/or the transparent top layer 116. The rigid wave surface 802 may have a plurality of peaks with a height 804 and a width 806. In some embodiments, the mold may comprise two opposed wave surfaces 902 which may be used under heat to mold the image display device 100 affording a 3-demensional effect to the image with the contorted bottom layer 118 and/or the transparent top layer 116. The rigid surface 902 may have a plurality of peaks with a height 904 and a width 906. In some embodiments, the mold may comprise two opposed arc surfaces 1002 which may be used under heat to mold the image display device 100 affording a 3-demensional effect to the image with the contorted bottom layer 118 and/or the transparent top layer 116. The arc surface 1002 may have a height 1006 and a width 1004. In some embodiments, the mold may comprise two opposed saw tooth surfaces 1102 which may be used under heat to mold the image display device 100 affording a 3-demensional effect to the image with the contorted bottom layer 118 and/or the transparent top layer 116. The saw tooth surface 1102 may have a plurality of peaks with a height 1104 and a tooth width 1106 and a width between teeth 1108. In some embodiments, the image display device 100 may afford a 3-demensional effect to the image with the contorted bottom layer 118 and/or the transparent top layer 116 exhibiting the shapes 802, 902, 1002 and/or 1102 with the introduction of heat without the use of a mold. The widths and heights of the shapes 802, 902, 1002 and/or 1102 may be between about 0.1 mm to 300 mm. Depending on the thermoplastic composition used a mold release agent may be used during the heating process to avoid adhesion to the mold. Examples of mold release agents include but are not limited to LMR Lecithin Mole Release, MAC 973 (McLube Division of McGee Industries, Inc.), MAC 444NPB (McLube Division of McGee Industries, Inc.), Loctite® Frekote® PU7000 and/or Loctite® Frekote® PU7001.

In some embodiments, the image display device further comprises an image enhancing coating on the first side of the transparent top layer and/or bottom layer. In some embodiments, the image enhancing coating is a varnish or a tint. Colored tints improve the optical properties of images after being printed on the film surface.

In another aspect, disclosed herein is a method for producing an image display device as disclosed herein, comprising providing a transparent top layer capable of being printed upon with a printing device, wherein the top layer comprises a first side and a second side, and wherein the transparent top layer overlays a viewing side of at least one image, wherein the transparent top layer comprises a thermoplastic polymer selected from the group consisting of a propylene-ethylene copolymer, a high density polyethylene polymer and a low density polyethylene polymer and polypropylene.

Images may be applied to the transparent top layer or a bottom layer using an ink jet printing method or a thermal transfer process. In some embodiments, the image is printed on the second side of the transparent top layer with the viewable side of the image facing the transparent top layer, thereby creating a barrier between the image and any potential damage. In some embodiments, the method for producing an image display device further comprises a bottom layer, wherein a first side of the bottom layer is affixed to the second side of the top layer. In some embodiments, the method for producing an image display device further comprises a bottom layer, wherein the bottom layer is affixed to the second side of the top layer, and wherein the at least one image is printed on a first side of the bottom layer. The bottom layer and/or the transparent top layer may be treated to improve receptivity to printing inks or adherence of affixed images as described herein. The bottom layer and/or the transparent top layer may be treated with an electric charge to improve receptivity to printing inks or adherence of affixed images. In some embodiments, the treatment to the layers used is corona treating.

The image display device of the present invention comprises two layers: a transparent top layer and the bottom layer. The layers are formed from polypropylene. The polypropylene derived layers may be printed upon employing a printing press with a master printing plate or printed via an intermediate substrate. Moreover, images may be printed onto a polypropylene derived layer employing Retro-gravure printing processes and with a template that employs a metal cylinder template. Another method of printing images onto the polypropylene derived layer is flexographic printing. In some embodiments, the bottom layer is comprised of polypropylene layers derived from polypropylene extruded with a metal, including but not limited to aluminum or other suitable metalized polypropylene. In some embodiments, the method for producing an image display device further comprises a bottom layer, wherein the bottom layer is affixed to the second side of the top layer, and wherein the bottom layer is metalized. In some embodiments, the method for producing an image display device further comprises a bottom layer, wherein the bottom layer is affixed to the second side of the top layer, wherein the bottom layer is metalized, and wherein a metal used for the metalized bottom layer is aluminum. In some embodiments, the method for producing an image display device further comprises a bottom layer, wherein the bottom layer is affixed to the second side of the transparent top layer, wherein the bottom layer is metalized, wherein a metal used for the metalized bottom layer is aluminum, and wherein the image is printed on a first side of the metalized bottom layer.

In some embodiments, the method for producing an image display device further comprises a step of heating the image display device that is capable of changing the shape of the image display device. In one example, the image display device 100 was heated at 400° F. for about 8 minutes. Depending on the type of mold as well as the mold material (i.e., wood, metal and plastic), additives and the film thickness the temperature range may be between about 300° F. to 600° F. and the heat exposure time could be between about 1 minutes to 10 minutes. In another aspect, if a mold is not used, the heating process results in the metalized bottom layer contorting and changing form from a flat surface to form ridges and/or bumps which give the layer a more 3-dimensional appearance. A shaping mold may be used to control the deformation to achieve a desired form. For example, a corrugated form can be used to achieve a “wave” shape. After the heating process and once the thermoplastic is cooled the layer(s) of the image display device become rigid.

In some embodiments, the method for producing an image display device further comprises the step of applying an image enhancing coating on the first side of the transparent top layer.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

The term “thermoplastic layer”, refers to a sheet material that is deformable under the application of heat and after cooling down retains the deformed shape and becomes rigid. The overall thickness of the sheet material is about 0.5 mm, 1.0 mm, 1.5 mm, 1.6 mm, 1.7 mm, 1.8 mm, 1.9 mm, 2.0 mm, 2.2 mm, 2.4 mm, 2.5 mm, 2.6 mm, 2.7 mm, 2.8 mm, 2.9 mm, 3.0 mm, 3.2 mm, 3.4 mm, 3.5 mm, 3.6 mm, 3.7 mm, 3.8 mm, 3.9 mm, or 4.0 mm. Moreover, the width and length of each layer may be between 1 inch and 120 inches. Examples of suitable thermoplastic polymers that can be used to form the layers include polypropylene, a high density polyethylene, a polypropylene copolymer such as an ethylene-propylene copolymer, a styrene polymer, a styrenic copolymer such as alpha-methyl styrene, and polyester such as a polyethylene terephthalate (PET) and a polyethylene terephthalate glycol copolymer (PETG). The layers may comprise a polypropylene monomer or other suitable thermoplastic materials. The metalized layer may be a polypropylene monomer sheet that has been altered to attract metal fibers. The metal fibers employed to produce the metalized layer may include aluminum or other suitable metals.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict any definitions in this disclosure.

What is claimed is:

1. An image display device for displaying wall art, comprising: a transparent top layer comprising a thermoplastic polymer, wherein the transparent top layer comprises a first side and a second side, and wherein the top layer overlays a viewing side of at least one image.

2. The image display device of claim 1, wherein the thermoplastic polymer is polypropylene.

3. The image display device of claim 1, further comprising a bottom layer, wherein a first side of the bottom layer is affixed to the second side of the top layer.

4. The image display device of claim 1, further comprising a bottom layer, wherein the bottom layer is affixed to the second side of the top layer, and wherein the at least one image is printed on a first side of the bottom layer.

5. The image display device of claim 1, further comprising a bottom layer, wherein the bottom layer is affixed to the second side of the top layer, and wherein the bottom layer is metalized.

6. The image display device of claim 1, further comprising a bottom layer, wherein the bottom layer is affixed to the second side of the top layer, wherein the bottom layer is metalized, and wherein a metal used for the metalized bottom layer is aluminum.

7. The image display device of claim 1, wherein the image is printed on the second side of the transparent top layer.

8. The image display device of claim 1, further comprising a bottom layer, wherein the bottom layer is affixed to the second side of the transparent top layer, wherein the bottom layer is metalized, wherein a metal used for the metalized bottom layer is aluminum, and wherein the image is printed on a first side of the metalized bottom layer.

9. The image display device of claim 1, further comprising an image enhancing coating on the first side of the transparent top layer.

10. The image display device of claim 9, wherein the image enhancing coating is a varnish or a tint.

11. A method for producing an image display device of claim 1, comprising providing a transparent top layer capable of being printed upon with a printing device, wherein the top layer comprises a first side and a second side, and wherein the transparent top layer overlays a viewing side of at least one image.

12. The method of claim 11, wherein the transparent top layer comprises a thermoplastic polymer selected from the group consisting of a propylene-ethylene copolymer, a high density polyethylene polymer and a low density polyethylene polymer and polypropylene.

13. The method of claim 11, further comprising a bottom layer, wherein a first side of the bottom layer is affixed to the second side of the top layer.

14. The method of claim 11, further comprising a bottom layer, wherein the bottom layer is affixed to the second side of the top layer, and wherein the at least one image is printed on a first side of the bottom layer.

15. The method of claim 11, further comprising a bottom layer, wherein the bottom layer is affixed to the second side of the top layer, and wherein the bottom layer is metalized.

16. The method of claim 11, further comprising a bottom layer, wherein the bottom layer is affixed to the second side of the top layer, wherein the bottom layer is metalized, and wherein a metal used for the metalized bottom layer is aluminum.

17. The method of claim 11, wherein the image is printed on the second side of the transparent top layer.

18. The method of claim 11, further comprising a bottom layer, wherein the bottom layer is affixed to the second side of the transparent top layer, wherein the bottom layer is metalized, wherein a metal used for the metalized bottom layer is aluminum, and wherein the image is printed on a first side of the metalized bottom layer.

19. The method of claim 11, further comprising a step of heating the image display device that is capable of changing the shape of the image display device.

20. The method of claim 11, further comprising the step of applying an image enhancing coating on the first side of the transparent top layer.
